(19) United States
(12) Patent Application Publication
(10) Pub. No.: US 2019/0329746 A1
(43) Pub. Date: Oct. 31, 2019

(54) HYDRAULIC REAR BRAKE MANUAL ACTUATION THROUGH ELECTRONIC STABILITY CONTROL SOFTWARE

(71) Applicant: Continental Automotive Systems, Inc., Auburn Hills, MI (US)

(72) Inventors: Fábio Niza Maximiuc, Lake Orion, MI (US); Gert-Rudolf Schneider, Troy, MI (US)

(73) Assignee: Continental Automotive Systems, Inc., Auburn Hills, MI (US)

(21) Appl. No.: 15/962,872

(22) Filed: Apr. 25, 2018

(51) Int. Cl. B60T 8/1755; G05G 1/04; B60T 1/06; B60T 7/08; B60T 7/12

(52) U.S. Cl. CPC B60T 8/1755; G05G 1/04; B60T 1/065; B60T 2201/00; B60T 7/12; B60T 2270/30; B60T 7/085

(57) ABSTRACT

A braking system having expanded functionality, which provides the driver of a vehicle the option to manually control the clamping force of the rear brakes as desired, while keeping existing braking system functionalities. The braking system includes a manual control device, such as a hand lever assembly, and the driver is able to move the hand lever to various positions. The position of the lever corresponds to an equivalent rear hydraulic brake clamping force request. A fully retracted lever corresponds to a complete release action of the rear hydraulic brakes, and a fully actuated lever corresponds to a complete clamping of the rear hydraulic brakes. Any position in between the fully retracted and fully actuated positions corresponds to a partial apply of the rear hydraulic brakes using a predefined ratio of force to lever position.

### FIELD OF THE INVENTION

The invention relates generally to controlling one or more hydraulic braking units using a manual control device, such as a hand lever, and electronic stability control software along with one or more braking units, to control vehicle dynamic.

### BACKGROUND OF THE INVENTION

Many current vehicles are equipped with an electronic parking brake (EPB). An EPB generally includes some type of brake unit having an electronic actuator in electrical communication with an electronic control unit (ECU), and there is also some type of switch which is selectively actuated by the driver of the vehicle for controlling the actuation of the EPB. The driver actuates the switch when desired such that a signal is sent to the ECU, and the ECU then sends a signal to the actuator to engage the brake unit, preventing the vehicle from moving.

Current EPB systems are typically configured to apply braking force only to the rear wheels, but do not provide for control by the driver over the amount of clamping force generated by the brake unit. These current EPB systems typically have two configurations, where the brake unit is either fully engaged, or fully released. In some applications, such as off-road use and on-road racing, it would be beneficial for the driver to apply braking force to only the rear wheels to adjust and better control the vehicle dynamic. However, because of current EPB systems having limited configurations, there is limited benefit in using the EPB system to control vehicle dynamic. Furthermore, typical braking systems apply braking force to all four wheels once force is applied to the brake pedal by the driver.

Accordingly, there exists a need for a braking system which has expanded functionality, allowing the driver to brake only the rear wheels, thereby having greater control over the vehicle dynamic.

### SUMMARY OF THE INVENTION

The present invention is a braking system having expanded functionality, which provides the driver of a vehicle the option to manually control the hydraulic braking force applied to the rear brakes as desired, while keeping existing braking system functionalities.

In one embodiment, the braking system according to the invention includes a manual control device, such as a hand lever assembly, where the hand lever assembly includes both a lever and a transducer for detecting lever position, both of which are installed in the vehicle and connected to an electronic control unit (ECU), or a hydraulic electronic control unit (HECU), where the ECU or the HECU are part of an Electronic Stability Control (ESC) device of the braking system, where either of the ECU or the HECU have ESC software.

The driver is able to move the hand lever to various positions. The position of the lever corresponds to an equivalent rear hydraulic brake clamping force request. A fully retracted lever corresponds to a complete release action of the rear hydraulic brakes, and a fully actuated lever corresponds to a complete clamping of the rear hydraulic brakes. Any position in between the fully retracted and fully actuated positions corresponds to a partial apply of the rear hydraulic brakes using a predefined ratio of force to lever position.

In one embodiment, the braking system includes an actuator, such as an electric motor which is used to move a piston to pressurize fluid in the braking system. In one embodiment, the ESC software is used to configure the actuator to generate the requested clamping force based on the position of the hand lever. Any change in the position of the hand lever assembly corresponds to an adjustment of the clamping force. In one embodiment, if the lever is pulled further, additional hydraulic pressure is generated, to increase the clamping force. A partial retraction of the hand lever generates a release action to install the new requested clamping force, according to the new position of the hand lever. Once the lever is fully retracted by the driver, the ESC software configures the actuator such that no clamping force is applied.

One of the advantages of the present invention is that the features of the present invention may be implemented into a vehicle without changing or developing a new brake caliper for the braking system.

In one embodiment, the present invention is a braking system, which includes a control device, such as a lever operable for being pivoted between a first position and a second position, and anywhere between the first position and second position, a stability control unit in electrical communication with the lever, at least one hydraulic actuator in electrical communication with the stability control unit, and at least one disc, such as a brake disc, where the hydraulic actuator is operable for selectively controlling a braking force applied to the disc.

The stability control unit sends a signal to the hydraulic actuator to allow the rotation of the disc when the lever is in the first position, and the electronic control unit sends a signal to the actuator to prevent the rotation of the disc when the lever is in the second position. The lever may also be pivoted such that the stability control unit sends a signal to the hydraulic actuator such that the hydraulic actuator generates a partial braking force applied to the disc, limiting the rotation of the disc.

In one embodiment, the braking system includes at least one caliper in fluid communication with the hydraulic actuator, and the hydraulic actuator configures the caliper to apply force to the disc when the lever is moved away from the first position. The amount of braking force applied to the disc by the caliper corresponds to the distance the lever is moved away from the first position and towards the second position.

In one embodiment, the disc is connected to the rear wheel of a vehicle. In yet another embodiment, there are two discs, where each disc is connected to a corresponding rear wheel of the vehicle. When the lever is moved away from the first position, the hydraulic actuator generates braking force such that the braking force is applied to both rear wheels.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a vehicle having an electronic parking brake system, according to embodiments of the present invention;

FIG. 2 is a diagram of an electronic parking brake system, according to embodiments of the present invention; and

FIG. 3 is an example of a hand lever assembly shown in the circled portion of FIG. 1.

### DETAILED DESCRIPTION OF THE PREFERRED EMBODIMENTS

The following description of the preferred embodiment(s) is merely exemplary in nature and is in no way intended to limit the invention, its application, or uses.

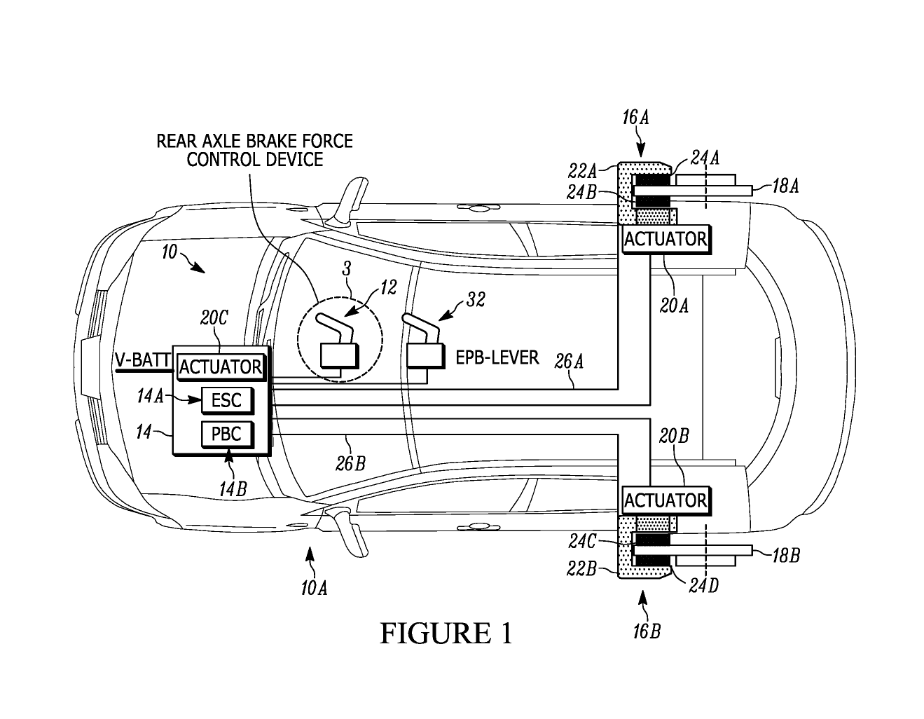

A diagram showing a vehicle 10A having a braking system according to the present invention is shown in FIG. 1, generally at 10. Referring to the Figures generally, the system 10 includes a control device, shown generally at 12, which in this embodiment is a lever 12 in electrical communication with an Electronic Stability Control (ESC) device 14. The ESC device 14 includes both ESC software, shown generally at 14A, and Parking Brake Control (PBC) software, shown generally at 14B. The braking system 10 also includes at least one brake unit, which in this embodiment is two brake units, shown generally at 16A,16B, where each brake unit 16A,16B is able to prevent the rotation of a corresponding rotatable element, which in this embodiment are two discs 18A,18B connected a corresponding wheel (not shown). Each brake unit 16A,16B includes an individual actuator 20A,20B in electrical communication with the ESC device 14, and each actuator 20A,20B is connected to and is able to actuate a corresponding caliper 22A,22B. Each caliper 22A,22B has two brake pads 24A,24B,24C,24D, and is able to apply force to the brake pads 24A,24B,24C,24D. Two of the brake pads 24A,24B are located on opposite sides of the first disc 18A, and the other two brake pads 24C,24D are located on opposite sides of the second disc 18B. The first actuator 20A is able to control the operation of the first caliper 22A such that the pads 24A,24B apply force to the first disc 18A, limiting or preventing rotation of the first disc 18A. The second actuator 20B is able to control the operation of the second caliper 22B such that the pads 24C,24D apply force to the second disc 18B, limiting or preventing rotation of the second disc 18B. The actuators 20A,20B are in electrical communication with the ESC device 14, are controlled by the PBC software 14B, and are used to perform parking brake functions.

The ESC device 14 also includes an actuator 20C, which in this embodiment is a hydraulic actuator 20C, which is in fluid communication with each caliper 22A,22B through fluid conduits 26A,26B. As with the first and second actuators 20A,20B, the hydraulic actuator 20C is able to control the operation of the first caliper 22A such that the pads 24A,24B apply force to the first disc 18A, limiting or preventing rotation of the first disc 18A, and the hydraulic actuator 20C is able to control the operation of the second caliper 22B such that the pads 24C,24D apply force to the second disc 18B, limiting or preventing rotation of the second disc 18B.

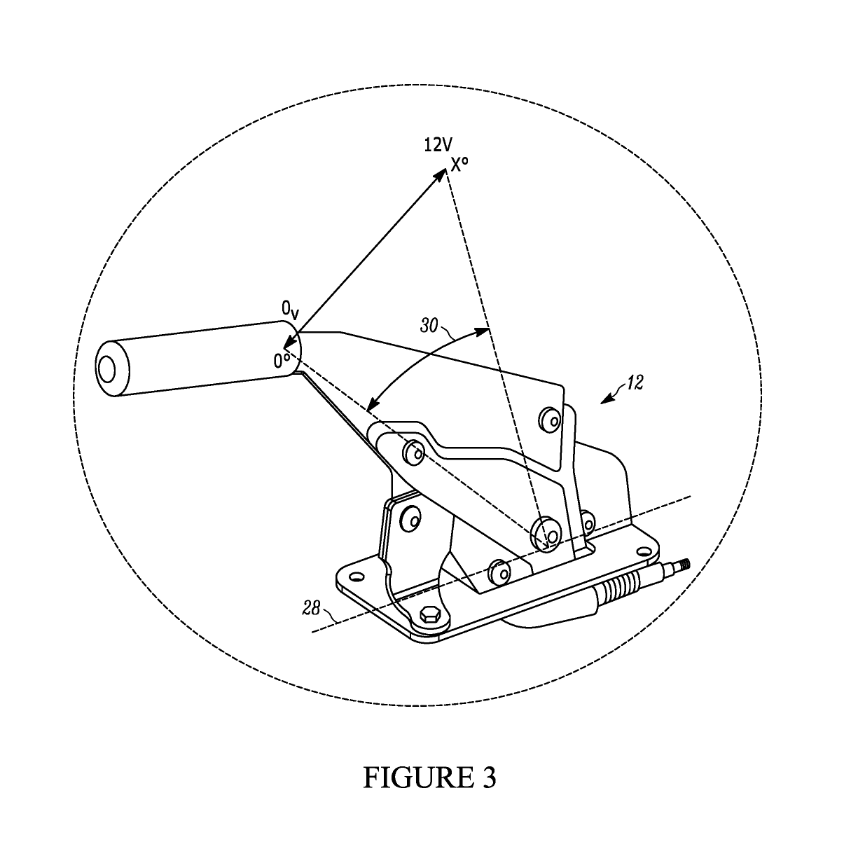

The lever 12 is able to be moved to various positions. More specifically, the lever 12 is able rotate about an axis 28 from a first position, shown in FIG. 3, to a second position, where the lever 12 has rotated an angular distance indicated by an angle 30, also shown in FIG. 3. The lever 12 also includes a transducer, which generates a voltage signal corresponding to the degree of which the lever 12 is pivoted about the axis 28, where the voltage signal from the transducer is sent to the ESC device 14, and the ESC device 14 sends a signal to the hydraulic actuator 20C representing the desired clamping force corresponding to the position of the lever 12, and therefore the corresponding clamping force is applied to each disc 18A,18B by each corresponding caliper 22A,22B as a result of hydraulic pressure generated by the hydraulic actuator 20C. The ESC device 14 includes software such that the ESC device 14 is programmed to command the hydraulic actuator 20C to generate a requested clamping force on the discs 18A,18B based on the position of the lever 12. In one embodiment, the hydraulic actuator 20C is a motor-gear-unit, which includes a DC motor connected to a gear box for torque amplification, and the gear box has an output shaft connected to a piston disposed in a cylinder. The piston is moved within the cylinder to increase or decrease the hydraulic pressure applied to the calipers 22A,22B. The hydraulic actuator 20C is able to maintain clamping force such that once the desired clamping force is achieved, the hydraulic actuator 20C is able to be deactivated (such that no current is applied to the DC motor of the hydraulic actuator 20C), while still maintaining the desired clamping force on the corresponding discs 18A,18B. The current consumption by the DC motor is used as a force estimation (i.e., the current consumption by the DC motor corresponds to the force applied to the discs 18A,18B), and the switch-off current to the DC motor is adjusted to achieve the desired clamping force on the discs 18A,18B by the calipers 22A,22B. In this embodiment, the “switch-off” current is the current level of the DC motor once the desired clamping force is achieved. Once the desired clamping force is achieved, the DC motor is deactivated, and the level of current at the time the DC motor is switched off is the “switch off” current. Although the hydraulic actuator 20C has been described as a motor-gear-unit, it is within the scope of the invention that other types of actuators may be used, such as, but not limited to, a stand-alone DC motor (no gear box), a brushless DC motor, a stepper motor, or the like, any of which may be used to move the piston within the cylinder.

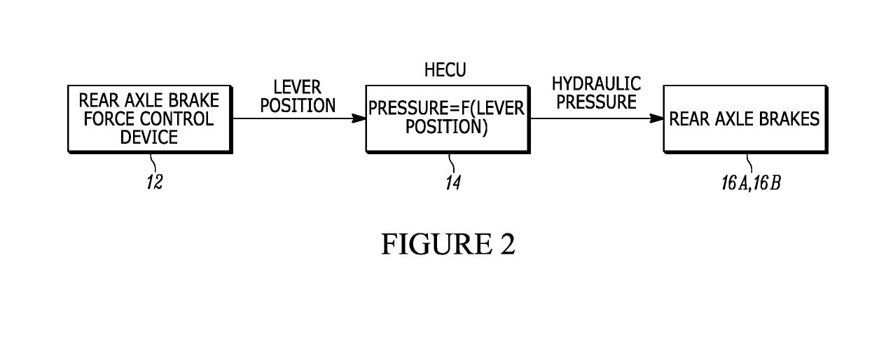

When the lever 12 is in the first position, shown in FIG. 3, a voltage signal of zero volts is sent from the lever 12 to the ESC device 14, such that no signal is sent from the ESC device 14 to the hydraulic actuator 20C, and therefore no hydraulic pressure generated by the hydraulic actuator 20C that is applied to the calipers 22A,22B. When the lever 12 is in the second position, a voltage signal of twelve volts is sent from the lever 12 to the ESC device 14, such that a signal corresponding to maximum clamping force is sent from the ESC device 14 to the hydraulic actuator 20C, and the maximum hydraulic pressure is generated by the hydraulic actuator 20C, such that the maximum clamping force is generated by the calipers 22A,22B. The lever 12 may also be placed anywhere between the first position and the second position such that a corresponding voltage signal anywhere between zero and twelve volts is sent from the lever 12 to the ESC device 14, such that a signal representing the desired clamping force corresponding to the position of the lever 12 is sent from the ESC device 14 to the hydraulic actuator 20C, and the desired clamping force is generated by the calipers 22A,22B. In the embodiment shown in FIGS. 1-3, there is a linear relationship between the position of the lever 12 and the clamping force applied to the discs 18A,18B by the calipers 22A,22B. However, it is within the scope of the invention that the relationship between the position of the lever 12 and the clamping force applied to the discs 18A,18B by the calipers 22A,22B may be non-linear, exponential, or have some other correlation such that the braking system 10 of the present invention may be best suited for a specific application, or the needs of the driver.

The braking system 10 also includes a switch 32, which is also in electrical communication with the ESC device 14. The switch 32 is used in combination with the PBC software 14B to actuate the brake units 16A,16B to perform the parking brake functions. The switch 32 has two configurations, in the first configuration, or “off position,” the switch 32 is configured such that the ESC device 14 does not send a signal to the actuators 20A,20B, and no force is applied to the discs 18A,18B. When the switch 32 is in the off position, the actuators 20A,20B configure the calipers 22A,22B to release the discs 18A,18B, such that the discs 18A,18B, and therefore the wheels, are allowed to rotate freely. In the second configuration, or “on position,” the switch 32 is configured to send a signal to the ESC device 14, and a signal corresponding to maximum clamping force is sent from the ESC device 14 to each actuator 20A,20B, and the actuators 20A,20B are then configured such that the clamping force generated by the calipers 22A,22B is maximized. When the switch 32 is in the on position, the clamping force applied to the discs 18A,18B by the calipers 22A,22B is maximized, and the discs 18A,18B, and therefore the wheels, are stationary, and prevented from rotating. The switch 32 may be used when the vehicle 10A is in a parked location, and it is desired to prevent the vehicle 10A from moving, such as when the vehicle 10A is parked on a hill.

In operation, the driver of the vehicle 10A may desire to change the vehicle dynamic. This may occur under different driving conditions, such as on-road racing, or when traveling off-road over various types of terrain. When the driver desires to change the vehicle dynamic, the driver may change the position of the lever 12, and rotate the lever 12 about the axis 28 from the first position to the second position, or anywhere between the first position and second position. When the lever 12 is in the first position, shown in FIG. 3, a voltage signal of zero volts is sent from the lever 12 to the ESC device 14, no signal is sent from the ESC device 14 to the hydraulic actuator 20C, and there is no force applied to the discs 18A,18B, and the discs 18A,18B, and therefore the wheels, are allowed to rotate freely. When the lever 12 is in the second position, a voltage signal of twelve volts is sent from the lever 12 to the ESC device 14, and a signal corresponding to maximum hydraulic pressure is sent to the hydraulic actuator 20C by the ESC device 14, such that the clamping force applied to the discs 18A,18B by the calipers 22A,22B is maximized, and the discs 18A,18B, and therefore the wheels, are stationary, and prevented from rotating. The lever 12 may also be placed in any position between the first position and the second position, where a partial clamping force is applied to the discs 18A,18B, reducing the rotational speed of the discs 18A,18B, and therefore the wheels, allowing the driver to change the vehicle dynamic.

Any adjustment in the position of the lever 12 changes the corresponding clamping force applied to the discs 18A,18B by the calipers 22A,22B. When the lever 12 is located anywhere between the first position and the second position, and the lever 12 is pulled further, a “re-clamp action” is generated, having a new switch-off current. However, if the lever 12 is partially retracted, a “release action” is generated, to implement the new requested clamping force which corresponds to the new position of the lever 12.

It has been described above that the hydraulic actuator 20C provides hydraulic pressure such that the clamping force is provided by both calipers 22A,22B simultaneously, such that the braking force is applied to both discs 18A,18B simultaneously. However, it is with the scope of the invention that the lever 12 could be replaced with a different control device such that the hydraulic actuator 20C and calipers 22A,22B could be configured to only apply braking force to one of the discs 18A,18B.

While the control device has been described above using the embodiment of the lever 12, it is within the scope of the invention that the lever 12 may be replaced with other types of control devices, such as knobs and different types of levers. Furthermore, while it has also been described above that each rotating element is a disc, the rotating element may be a drum, or any other type of rotating element such that the braking system 10 described above may be suitable for use with various types of braking units.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
an braking system, including:
a control device;
a stability control unit in electrical communication with the control device;
at least one hydraulic actuator in electrical communication with the stability control unit;
a first braking unit in fluid communication with the at least one hydraulic actuator;
a second braking unit in fluid communication with the at least one hydraulic actuator; and
a plurality of rotatable elements, the first braking unit operable for applying a braking force to a first of the plurality of rotatable elements, and the second braking unit operable for applying a braking force to a second of the plurality of rotatable elements;
wherein the stability control unit sends a signal to the at least one hydraulic actuator to actuate the first braking unit and the second braking unit, controlling the rotation of the first of and the second of the plurality of rotatable elements based on the configuration of the control device.

2. The apparatus of claim 1, further comprising:
a first configuration, the control device operable for being placed in the first configuration;
wherein the stability control unit sends a signal to the at least one hydraulic actuator such that no force is applied to the plurality of rotatable elements by the first braking unit or the second braking unit when the control device is placed in the first configuration, allowing the plurality of rotatable elements to rotate freely.

3. The apparatus of claim 1, further comprising:
a second configuration, the control device operable for being placed in the second configuration;
wherein the stability control unit sends a signal to the at least one hydraulic actuator when the control device is placed in the second configuration such that the braking force is applied to the first of the plurality of rotatable elements by the first braking unit, and the braking force is applied to the second of the plurality of rotatable elements by the second braking unit, preventing rotation of the first of the plurality of rotatable elements, and the second of the plurality of rotatable elements.

4. The apparatus of claim 1, wherein the control device is placed in a configuration such that the stability control unit sends a signal to the at least one hydraulic actuator such that the first braking unit applies a partial braking force to the first of the plurality of rotatable elements, and the second braking unit applies a partial braking force to the second of the plurality of rotatable elements, limiting the rotation of the first of the plurality of rotatable elements, and the second of the plurality of rotatable elements.

5. The apparatus of claim 1, further comprising:
a first caliper in fluid communication with the at least one hydraulic actuator, the first caliper being part of the first brake unit; and
a second caliper in fluid communication with the at least one hydraulic actuator, the second caliper being part of the second brake unit;
wherein the at least one hydraulic actuator configures the first caliper to apply force to the first of the plurality of rotatable elements, and the at least one hydraulic actuator configures the second caliper to apply force to the second of the plurality of rotatable element when the lever is in the second position, or positioned anywhere between the first position and the second position.

6. The apparatus of claim 1, the control device being one selected from the group consisting of a knob and a lever.

7. The apparatus of claim 1, wherein the first of the plurality of rotatable elements is connected to a first rear wheel of a vehicle, and the second of the plurality of rotatable elements is connected to a second rear wheel of a vehicle.

8. A braking system, comprising:
a lever operable for being pivoted between a first position and a second position, and anywhere between the first position and second position;
a stability control unit in electrical communication with the lever;
at least one hydraulic actuator in electrical communication with the stability control unit;
at least one disc, the at least one hydraulic actuator operable for selectively controlling a braking force applied to the at least one disc;
wherein the stability control unit sends a signal to the at least one hydraulic actuator to allow the rotation of the at least one disc when the lever is in the first position, and the electronic control unit sends a signal to the actuator to prevent the rotation of the at least one disc when the lever is in the second position.

9. The braking system of claim 8, wherein the lever is pivoted such that the stability control unit sends a signal to the at least one hydraulic actuator such that the at least one hydraulic actuator generates a partial braking force to the at least one disc, limiting the rotation of the at least one disc.

10. The braking system of claim 8, further comprising at least one caliper in fluid communication with the at least one hydraulic actuator, wherein at least one hydraulic actuator configures the at least one caliper to apply force to the at least one disc when the lever is moved away from the first position.

11. The braking system of claim 10, wherein the amount of braking force applied to the at least one disc by the at least one caliper corresponds to the distance the lever is moved away from the first position and towards the second position.

12. The braking system of claim 8, wherein the at least one disc is connected to the rear wheel of a vehicle.
